(19) United States
(12) Patent Application Publication
(10) Pub. No.: US 2026/0351442 A1
(43) Pub. Date: Nov. 5, 2026

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: DUO CHEN, Kunshan (CN); Yang-Bo Zheng, Kunshan (CN); Jian-Guo Cai, Kunshan (CN); Juan Zheng, Kunshan (CN); Lu-Yu Chang, New Taipei (TW)

(21) Appl. No.: 19/659,268

(22) Filed: Apr. 27, 2026

(30) Foreign Application Priority Data
Apr. 30, 2025 (CN) 202520851411.5

(51) Int. Cl. H01B 7/08; H01B 3/30; H01B 7/00; H01B 7/02

(52) U.S. Cl. CPC H01B 7/0823; H01B 3/30; H01B 7/0009; H01B 7/0225; H01B 7/0275; H01B 7/0807; H01B 7/0861

(57) ABSTRACT

A cable includes: a pair of core wires; a sheath covering the pair of core wires; a shielding layer covering the sheath; an outer insulating layer covering the shielding layer; and a pair of bare ground wires disposed between the sheath and the shielding layer; wherein the cross section of each of the pair of core wires is circular, the pair of core wires are arranged side by side in a transverse direction, the sheath is extruded over the pair of core wires to leave no air gap between the sheath and the pair of core wires, each of two outer sides of the sheath in the transverse direction has a limiting space, and each of the bare ground wires is at least partially accommodated and fixed in the limiting space.

### BACKGROUND OF THE INVENTION

### Field of the Invention

The present invention relates generally to a cable, and more particularly to a cable that has good electrical performance to transmit high-frequency signals.

### Description of Related Arts

With the rapid development of technologies such as big data, artificial intelligence (AI), and cloud computing, the demand for computing performance and data storage in servers and other equipment is increasing. Traditional cables can no longer meet the transmission requirements of 224G and 1.6T. At the same time, with the ongoing advancement of Industry 4.0, more and more manual operations are being replaced by robots and automated equipment. To ensure that automated equipment can accurately complete processing tasks, the size of the product is crucial. The significant misalignment of the ground wire caused considerable inconvenience to the processing of automated equipment. The offset of the ground wire caused structural asymmetry in the cable, resulting in a large deviation in the S-parameters and ultimately leading to product defects.

U.S. Pat. No. 10,643,766 discloses a cable comprising a pair of core wires, an insulating outer sheath covering the pair of core wires, and a ground wire. Each core wire includes an inner conductor and an inner insulation layer covering the inner conductor. The outer side of the pair of core wires has a limiting space and the bare ground wire is at least partially accommodated and fixed in the limiting space.

It is desired to provide an improved cable with stable structure and reliable signal transmission.

### SUMMARY OF THE INVENTION

A main object of the present invention is to provide a cable with stable structure and good electrical performance.

To achieve the above object, a cable includes: a pair of core wires; a sheath covering the pair of core wires; a shielding layer covering the sheath; an outer insulating layer covering the shielding layer; and a bare ground wire disposed between the sheath and the shielding layer; wherein the cross section of each of the pair of core wires is circular, the pair of core wires are arranged side by side in a transverse direction, the sheath is extruded over the pair of core wires to leave no air gap between the sheath and the pair of core wires, each of two outer sides of the sheath in the transverse direction has a limiting space, and each of the bare ground wires is at least partially accommodated and fixed in the limiting space.

Compared to prior art, the sheath has a limited space, so that the position of the bare ground wire is relatively fixed. Additionally, the sheath is extruded over the pair of core wires so relative position of the two inner conductors is fixed. Furthermore, there is no air gap between the sheath and the pair of core wires, making the cable an integrated structure and the positions of the two core wires are not easily changed during subsequent processing.

### BRIEF DESCRIPTION OF THE DRAWING

FIG. 1 is a cross-sectional view of a first embodiment of a cable of the present invention;

FIG. 2 is a cross-sectional view of a second embodiment of a cable of the present invention;

FIG. 3 is a cross-sectional view of a third embodiment of a cable of the present invention; and

FIG. 4 is a cross-sectional view of a fourth embodiment of a cable of the present invention.

### DETAILED DESCRIPTION OF THE PREFERRED EMBODIMENT

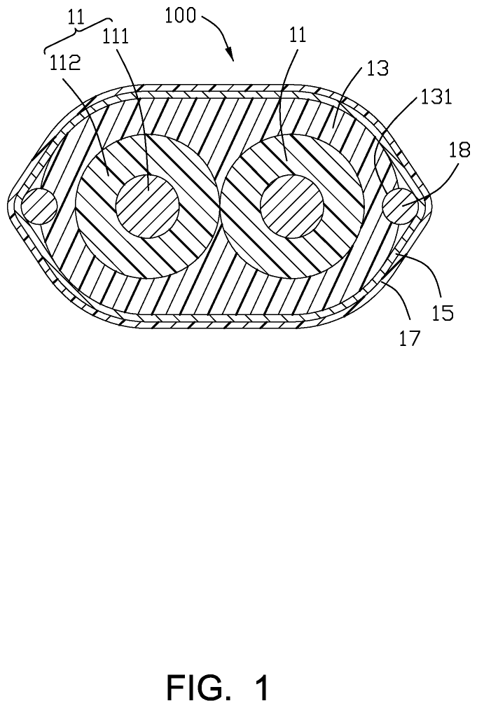

Referring to FIG. 1, the first embodiment of the cable 100 of the present invention is shown. The cable 100 comprises a pair of core wires 11, a sheath 13 covering the pair of core wires 11, a shielding layer 15 covering the sheath 13, an outer insulating layer 17 covering the shielding layer 15, and a bare ground wire 18 disposed between the sheath 13 and the shielding layer 15.

The cross section of each of the pair of core wires 11 is circular. The pair of inner core wires 10 are arranged side by side and are in contact with each other. Each of the pair of inner core wires 11 includes an inner conductor 111 and an inner insulating layer 112 covering the inner conductor 111. The inner conductor 111 is used to transmit high-speed signals. The inner conductor 111 is selected from the group consisting of silver-plated copper, tin-plated copper, and bare copper. The inner insulating layer 112 covers the respective inner conductor 111 by extrusion molding. Each pair of inner core wires 11 is manufactured separately, facilitating dimensional control and management. The inner insulating layers 112 of the two core wires 11 are adjacent to each other. The inner insulating layer 112 is selected from the group consisting of FEP (Fluorinated ethylene propylene), PFA (Perfluoroalkoxy), PE (polyethylene), PTFE (Polytetrafluoroethylene), PP (polypropylene), and TPX (Polymethylpentene).

The sheath 13 has limiting spaces 131 on two outer sides in the transverse direction. The bare ground wire 18 is at least partially accommodated and fixed in the limiting spaces 131. The sheath 13 is extruded over the pair of core wires 11. The two inner conductors 111 are separated by the thickness of two inner insulating layers 112. In this way, the relative positions of the two inner conductors 111 are fixed. There is no air gap between the sheath 13 and the pair of core wires 11. The material of the sheath 13 is selected from the group consisting of FEP, PFA, PE, PTFE, PP, and TPX.

The cable 100 further comprises a pair of ground wires 18. The pair of bare ground wires 18 are respectively disposed in the limiting spaces 131. The centers of the pair of bare ground wires 18 and the centers of the pair of inner conductors 111 are on the same straight line. The bare ground wire 18 is made of silver-plated copper, tin-plated copper, and bare copper. In other embodiments, only one bare ground wire 18 and one limiting space 131 may be provided.

The shielding layer 15 is covered the sheath 13 in a longitudinally manner or wrapped around the sheath 13 in a spiral wound manner. The shielding layer 15 is selected from the group consisting of aluminum foil, copper foil, silver-plated copper foil, alloy copper foil, and copper-aluminum composite tape. The metal layer can be either single-sided or double-sided, and can be with or without an adhesive surface.

The material of the outer insulating layer 17 is Mylar or PI. The outer insulating layer 17 can be one or multiple layers; specifically, in this embodiment, the outer insulating layer 17 has two layers. The outer insulating layer 17 is spirally wound around the outside of the shielding layer 15. The outer insulating layer 17 has adhesive on it.

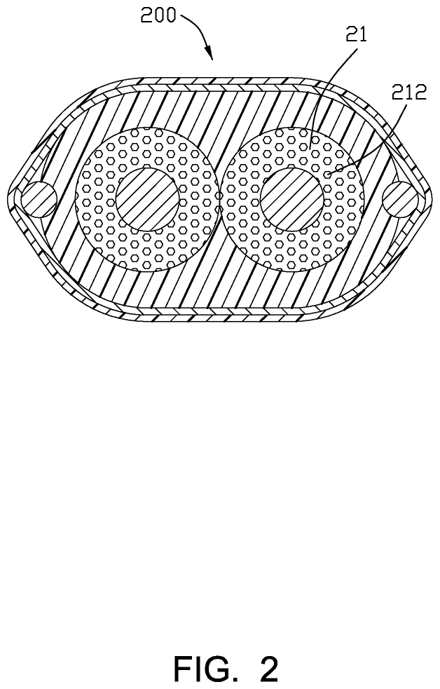

FIG. 2 shows the second embodiment of a cable 200 of the present invention. Compared with the first embodiment, in this embodiment, the inner insulating layer 212 of the core wire 21 is made of a foamed material. Specifically, the material of the inner insulating layer 212 is one of foamed FEP, foamed PFA, foamed PE, foamed PTFE, foamed PP, or foamed TPX.

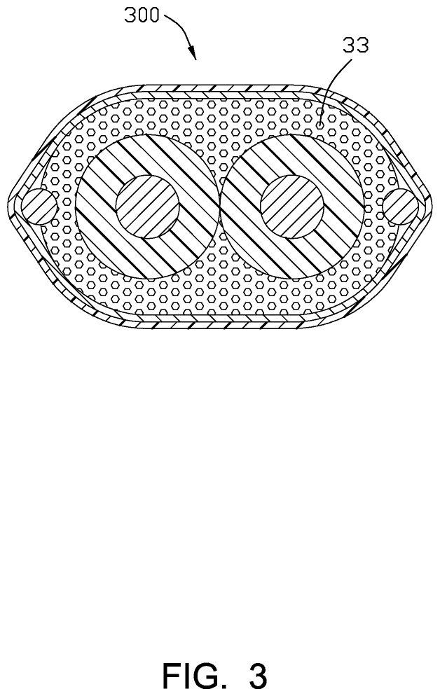

FIG. 3 shows the third embodiment of the cable 300 of the present invention. Compared with the first embodiment, in this embodiment, the sheath 33 is made of a foamed material. Specifically, in this embodiment, the material of the sheath 33 is one of foamed FEP, foamed PFA, foamed PE, foamed PTFE, foamed PP, or foamed TPX.

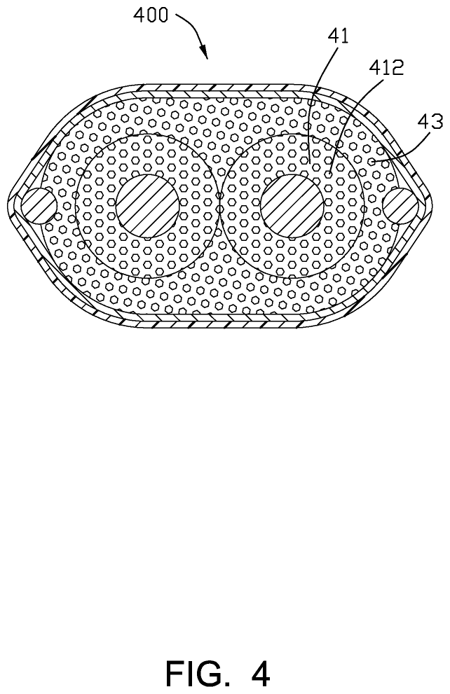

FIG. 4 shows the fourth embodiment of the cable 400 of the present invention. Compared with the previous embodiments, in this embodiment, both the inner insulating layer 412 of the core wire 41 and the sheath 43 are made of foamed material. Specifically, in this embodiment, the material of the inner insulating layer 412 is one of foamed FEP, foamed PFA, foamed PE, foamed PTFE, foamed PP, or foamed TPX, and the material of the sheath 43 is also one of foamed FEP, foamed PFA, foamed PE, foamed PTFE, foamed PP, or foamed TPX.

In the cable 100 of the present invention has limiting spaces 131 on two sides of the sheath 13 to secure the bare ground wires 18, ensuring that the bare ground wires 18 are not affected by the rotational force of the outer insulating layer 17. The position of the bare ground wires 18 is relatively fixed. Additionally, the sheath 13 is extruded over the pair of core wires 11, so that the two inner conductors 111 are separated by the thickness of two inner insulating layers 112, thereby fixing the relative position of the two inner conductors 111, and there is no air gap between the sheath 13 and the pair of core wires 11, making the cable 100 an integrated structure, and preventing the positions of the two core wires 11 from easily shifting during subsequent processing.

1. A cable comprising:
a pair of core wires;
a sheath covering the pair of core wires;
a shielding layer covering the sheath;
an outer insulating layer covering the shielding layer; and
a pair of bare ground wires disposed between the sheath and the shielding layer; wherein
the cross section of each of the pair of core wires is circular, the pair of core wires are arranged side by side in a transverse direction, the sheath is extruded over the pair of core wires to leave no air gap between the sheath and the pair of core wires, each of two outer sides of the sheath in the transverse direction has a limiting space, and each of the bare ground wires is at least partially accommodated and fixed in the limiting space.

2. The cable as claimed in claim 1, wherein each of the pair of core wires comprises an inner conductor and an inner insulating layer surrounding the inner conductor.

3. The cable as claimed in claim 2, wherein the centers of the pair of bare ground wires and the centers of the pair of inner conductors are aligned.

4. The cable as claimed in claim 2, wherein at least one of the inner insulating layer and the sheath is made of a foam material.

5. The cable as claimed in claim 2, wherein the inner insulating layer is made of a material selected from the group consisting of FEP, PFA, PE, PTFE, PP, TPX, foamed FEP, foamed PFA, foamed PE, foamed PTFE, foamed PP, and foamed TPX.

6. The cable as claimed in claim 2, wherein the sheath is made of a material selected from the group consisting of FEP, PFA, PE, PTFE, PP, TPX, foamed FEP, foamed PFA, foamed PE, foamed PTFE, foamed PP, and foamed TPX.

7. The cable as claimed in claim 2, wherein the inner conductor is made of a material selected from the group consisting of silver-plated copper, tin-plated copper, and bare copper.

8. The cable as claimed in claim 1, wherein the bare ground wire is made of a material selected from the group consisting of silver-plated copper, tin-plated copper, and bare copper.

9. The cable as claimed in claim 1, wherein the shielding layer is made of a material selected from the group consisting of aluminum foil, copper foil, silver-plated copper foil, alloy copper foil, and copper-aluminum composite tape.

10. The cable as claimed in claim 1, wherein the outer insulating layer is one or multiple layers of Mylar or PI material.
